(19) United States
(12) Patent Application Publication
(10) Pub. No.: US 2004/0236009 A1
(43) Pub. Date: Nov. 25, 2004

(54) Low density adhesives and sealants

(76) Inventors: Robson Mafoti, Temple, TX (US); Yuduo Zhu, Grand Prairie, TX (US)

Correspondence Address: Thomas C. Wright, Gardere Wynne Sewell LLP, 1601 Elm Street, Suite 3000, Dallas, TX, 75201, US

(21) Appl. No.: 10/444,344

(22) Filed: May 23, 2003

(51) Int. Cl. C08L 83/00

(52) U.S. Cl. 524/588

(57) ABSTRACT

The present invention includes compositions of, and methods for creating, adhesive and sealant materials that offer reduced densities and costs without substantially affecting the adhesive properties associated with the materials.

### BACKGROUND OF THE INVENTION

Modified silicone polymers, which are essentially polyether polymers with additional reactive silane functionality are known in the adhesive and sealant industry as very useful materials. The advantages offered by the combination of curing characteristics, and the properties of the material once cured, make them very popular for use in a wide variety of applications and industries.

As with any commercially useful compound, a material that meets the same standards of performance at a reduced cost is desirable. This is especially true of modified silicone polymers due to the relatively expensive nature of these materials relative to other adhesives.

The present invention allows the cost of modified silicone polymers to be reduced without adversely affecting the properties that make these materials popular.

### SUMMARY OF THE INVENTION

The present invention is directed to new and improved compositions of, and methods for creating, adhesive and sealant materials, also referred to herein as curable materials, that offer reduced densities without substantially affecting the adhesive and sealant properties associated with the materials.

In one form, the present invention is a curable composition with reduced density made up of a curable material and a weight reducing material that decreases the density of the adhesive and sealant compound without substantially affecting the adhesive and sealant properties of the curable compound.

In another form, the present invention is a method for preparing a curable composition with reduced density that includes the steps of obtaining an adhesive and sealant material and adding a weight reducing material that decreases the density of the curable compound without substantially affecting the adhesive properties of the curable compound.

### DETAILED DESCRIPTION OF THE INVENTION

Specific objects features and advantages of the invention will be readily understood and appreciated by reference to the following detailed description. The description is meant to be read with reference to the tables contained herein. This detailed description relates to examples of the claimed subject matter for illustrative purposes, and is in no way meant to limit the scope of the invention. Throughout this document, the term “curable” will be used to reference to both adhesives and sealants, unless specifically noted otherwise.

### EXAMPLES

A general procedure has been used for the preparation of the following compounds. It will be appreciated by those skilled in the art, after reading this application, that the specific general procedure is not the only means for achieving the results described, and modification that do achieve such results are considered to be part of the present invention.

An initial step is the grinding to the starting materials to achieve a uniform consistency and to aid in the drying process that forms one of the steps of methods of the present invention. Typically, the polymers, fillers, pigments, UV absorbers and thixotropic agents that are to form the basis of a composition are combined and ground to a fine paste.

These ground ingredients are then combined with a plasticizer and solvent, and dried. Toluene is an example of a solvent that may be used, although others may be used to azeotropically remove any water present in any of the ingredients. Drying is achieved by heating the solution to be dried, typically to at least about 240 degrees Fahrenheit, and reducing the pressure to below atmospheric to aid in the removal of any water that is present. By using this method it is possible to achieve water concentrations as low as 0.01-0.05 weight percent, preferably 0.01-0.03 weight percent. By drying in this manner, the addition of water scavenging compounds is not required.

Following the drying step, the dried materials are combined with, typically, a dehydration agent, an adhesion promoter and a density reducing material. The density reducing material is typically a microspherical material, such as EXPANCEL®. It is important that the material that is chosen, while reducing the density of the overall composition, does not substantially affect the end product curable properties.

After all of the ingredients of the composition have been sufficiently combined, reduced pressure may once again be applied. This helps to remove any entrapped air that may be present in the finished formulation. Following the removal of the air, the material may be processed and packaged by whatever means necessary to produce the desired end product. The material may be placed in tubes, or drums for eventual use in the application of choice.

Five compositions were prepared with and without the addition of a density-reducing compound. Tables 1 and 2 show the compositions and measurements, respectively, for those five compounds in the absence of a density reducing agent. Tables 3 and 4 show the compositions and measurements, respectively, for those five compounds in the presence of a density reducing agent. The following procedure was generally followed for the preparation of each of the five compositions.

Composition #1 was prepared by combining 500 grams of MS Polymer S203H (a silylated polyether from Kaneka) and 644 grams of MS Polymer S303H. 1150 grams of a calcium carbonate (e.g., Winnofil SPM) and 550 g of a second calcium carbonate (e.g., Duramite) were added to the polymers along with 130 grams of a titanium dioxide and 39 grams of wax (e.g., Aristowax). These materials were then ground into a fine paste.

To the paste was added 860 grams of a plasticizer (e.g., Jayflex DIDP) and 750 grams of toluene. All of these materials were placed in a reactor that was heated to 240 degrees Fahrenheit for at least two hours and may be under reduced pressure. After the reactor cooled down, more toluene was added and the drying step repeated until the water content of the resulting material is less than 0.05 weight percent. An amount of SR-34 (Silquest A-171-vinylsilane from OSI) was then added based on the water content. In one embodiment, SR34 acts as a coupler and water scavenger.

After the material had cooled to a temperature of about 100 degrees Fahrenheit, 22.46 grams of Silquest A-171 and 20.00 grams of Silquest A-187 were added along with 20.00 grams of a hardening catalyst such as Neostann U-220H. The entire mixture was then stirred for 20 minutes followed by 20 minutes of exposure to a vacuum to remove any trapped air.

The ingredients and amounts of Compositions 1 through 5 appear in Table 1. The same general procedure was used to prepare Compositions 6 through 10. The exact ingredients used to prepare Compositions 6 through 10 are shown in Table 3. There are no major differences between the corresponding compositions in the two sets, i.e., Composition 1 and Composition 6 are essentially identical except that for the addition of the density reducing compound, in this case EXPANCEL®, in the latter compound.

Comparison of Tables 3 and 4 indicates that the density, or specific gravity, of Compositions 6 through 10 have been greatly reduced with respect to the densities of the corresponding Composition 1 through 5. However, a comparison of the physical properties of the cured materials indicates that the reduction in density does no adversely effect the properties of the resulting sealant. The materials prepared in accordance with the present invention are considered equivalent for industrial purposes using industrial standards.

Although preferred embodiments of the present invention have been described in detail herein, those skilled in the art will recognize that various substitutions and modifications may be made to the invention without departing from the scope and spirit of the appended claims.

TABLE 1
Ingredients of Compositions 1 through 5 without Expancel

| | | #1 | | #2 | | #3 | | #4 | | #5 | |
|---|---|---|---|---|---|---|---|---|---|---|---|
| Item | Chemical | Weight | % | Weight | % | Weight | % | Weight | % | Weight | % |
| 1 | MS Polymer S203H | 500 | 10.67 | 500 | 10.67 | 500 | 10.67 | 500 | 10.67 | 500 | 10.67 |
| 2 | MS Polymer S303H | 644 | 13.74 | 644 | 13.74 | 644 | 13.74 | 644 | 13.74 | 644 | 13.74 |
| 3 | Winnofil SPM | 1150.00 | 24.54 | 1150.00 | 24.54 | 1150.00 | 24.54 | 1150.00 | 24.54 | 1150.00 | 24.54 |
| | (CaC03) | | | | | | | | | | |
| 4 | Duramite (CaC03) | 550.00 | 11.74 | 550.00 | 11.74 | 550.00 | 11.74 | 550.00 | 11.74 | 550.00 | 11.74 |
| 5 | Ti-Pure R902 (Ti02) | 130.00 | 2.77 | 130.00 | 2.77 | 130.00 | 2.77 | 130.00 | 2.77 | 130.00 | 2.77 |
| 6 | Aristowax 143 (Wax) | 39.00 | 0.83 | 39.00 | 0.83 | 39.00 | 0.83 | 39.00 | 0.83 | 39.00 | 0.83 |
| 7 | Jayflex DIDP | 860.00 | 18.35 | 860.00 | 18.35 | 860.00 | 18.35 | 860.00 | 18.35 | 860.00 | 18.35 |
| 8 | Toluene | 750.00 | 16.01 | 750.00 | 16.01 | 750.00 | 16.01 | 750.00 | 16.01 | 750.00 | 16.01 |
| 9 | Silquest A-171 | 22.46 | 0.48 | 22.46 | 0.48 | 22.46 | 0.48 | 22.46 | 0.48 | 22.46 | 0.48 |
| | (VTMO) | | | | | | | | | | |
| | Silquest A-187 | 20.00 | 0.43 | | | 20.00 | 0.43 | 20.00 | 0.43 | | |
| 10 | Silquest A-1120 | | | 20.00 | 0.43 | | | | | 20.00 | 0.43 |
| | Dibutyltin Diaurate | | | | | 20.00 | 0.43 | | | | |
| | Neostann U-220H | 20.00 | 0.43 | 20.00 | 0.43 | | | | | | |
| 11 | Fomrez SUL-11A | | | | | | | 20.00 | 0.43 | 20.00 | 0.43 |
| Total | | 4685.46 | 100.00 | 4685.46 | 100.00 | 4685.46 | 100.00 | 4685.46 | 100.00 | 4685.46 | 100.00 |

TABLE 2
Measurements of Compositions 1 through 5 without Expancel

| | #1 | #2 | #3 | #4 | #5 |
|---|---|---|---|---|---|
| Moisture, % | 0.0322 | 0.0247 | 0.0041 | 0.0306 | 0.01907 |
| | 0.0188 | 0.0132 | 0.01 | 0.0183 | 0.02379 |
| Sp. Gravity | 12.17 | 12.14 | 12.07 | 11.95 | 12.04 |
| Solid, % | 97.46 | 97.78 | 97.51 | 98.05 | 97.23 |
| Viscosity, Sec/20 G | 7.7 | 7.5 | 7.6 | 6.2 | 5.5 |
| Gravity, #/Gallon | 12.17 | 12.14 | 12.07 | 11.95 | 12.04 |
| Channel Sag, inch | 0 | 0 | 0 | 0 | 0 |
| Shore A, Condition | 16.2 | 20 | 12.7 | 12.4 | 23 |
| Shore A, QUV | 16 | 20.3 | 12.6 | 12.4 | 23 |
| Tensile, psi | 128.3 | 213.2 | 46.7 | 121.3 | 216.9 |
| Elongation, % | 848.9 | 911.3 | 910 | 843 | 743.8 |
| 100% Modulus, psi | 27.94 | 45.4 | 8.1 | 25.6 | 52.3 |
| 50% Modulus, psi | 16.67 | 23.7 | 4.3 | 15.4 | 27 |
| 25% Modulus, psi | 9.55 | 11.6 | 2.1 | 8.7 | 14.6 |
| Peel-Glass, pli | 24.75 CF | 27 CF | 21.2 CF | 25 CF | 29.3 CF |
| Peel-Aluminum, pli | 20.75/80/20 CF/AF | 27.7 CF | 6.8 AF | 6 AF | 27.3 CF |
| Peel-Concrete, pli | 15 AF | 14.3 AF | 8.0 AF | 12.3 AF | 30 CF/AF90/10 |

TABLE 3
Ingredients of Compositions 6 through 10 with Expancel

| | | #6 | | #7 | | #8 | | #9 | | #10 | |
|---|---|---|---|---|---|---|---|---|---|---|---|
| Item | Chemical | Weight | % | Weight | % | Weight | % | Weight | % | Weight | % |
| 1 | MS Polymer S203H | 500.00 | 10.56 | 500 | 10.57 | 500.00 | 11.65 | 500.00 | 10.66 | 500.00 | 10.03 |
| 2 | MS Polymer S303H | 644.00 | 13.60 | 644 | 13.62 | 644.00 | 15.01 | 644.00 | 13.73 | 644.00 | 12.92 |
| 3 | Winnofil SPM | 1150.00 | 24.29 | 1150.00 | 24.32 | 900.00 | 20.98 | 1150.00 | 24.52 | 1450.00 | 29.08 |
| | (CaC03) | | | | | | | | | | |
| 4 | Duramite (CaC03) | 550.00 | 11.62 | 550.00 | 11.63 | 400.00 | 9.32 | 550.00 | 11.73 | 550.00 | 11.03 |
| 5 | Ti-Pure R902 (Ti02) | 130.00 | 2.75 | 130.00 | 2.75 | 130.00 | 3.03 | 130.00 | 2.77 | 130.00 | 2.61 |
| 6 | Aristowax 143 (Wax) | 39.00 | 0.82 | 39.00 | 0.82 | 39.00 | 0.91 | 39.00 | 0.83 | 39.00 | 0.78 |
| 7 | Jayflex DIDP | 860.00 | 18.16 | 860.00 | 18.18 | 860.00 | 20.04 | 860.00 | 18.33 | 860.00 | 17.25 |
| 8 | Toluene | 750.00 | 15.84 | 750.00 | 15.86 | 750.00 | 17.48 | 750.00 | 15.99 | 750.00 | 15.04 |
| 9 | Silquest A-171 | 22.46 | 0.47 | 22.46 | 0.47 | 13.56 | 0.32 | 13.65 | 0.29 | 13.65 | 0.27 |
| | (VTMO) | | | | | | | | | | |
| | Silquest A-187 | | | | | | | | | | |
| 10 | Silquest A-1120 | 20.00 | 0.42 | 20.00 | 0.42 | 15.00 | 0.35 | 15.00 | 0.32 | 15.00 | 0.30 |
| 11 | Disperbyk 161 | 4.00 | 0.08 | 4.00 | 0.08 | 4.00 | 0.09 | 4.00 | 0.09 | 4.00 | 0.08 |
| 12 | Expancel | 50.00 | 1.06 | 40.00 | 0.85 | 20.00 | 0.47 | 20.00 | 0.43 | 20.00 | 0.40 |
| | Dibutyltin Diaurate | | | | | | | | | | |
| | Neostann U-220H | 15.00 | 0.32 | 20.00 | 0.42 | 15.00 | 0.35 | 15.00 | 0.32 | 10.00 | 0.20 |
| | XP7179 | 3.00 | 0.06 | | | | | | | | |
| 11 | Fomrez SUL-11A | | | | | | | | | 10.00 | 0.20 |
| Total | | 4734.46 | 100.00 | 4729.46 | 100.00 | 4290.56 | 100.00 | 4690.65 | 100.00 | 4985.65 | 100.00 |

TABLE 4
Measurements of Compositions 6 through 10 with Expancel

| | #6 | #7 | #8 | #9 | #10 |
|---|---|---|---|---|---|
| Gravity, lb/gallon | 8.93 | 9.16 | 9.40 | 10.00 | 10.33 |
| Moisture content, % | 0.0217 | 0.0230 | 0.0100 | 0.0093 | 0.0178 |
| | 0.0132 | 0.0180 | 0101792 | 0.0140 | 0.0290 |
| Solid, % | 97.81 | 96.87 | 97.51 | 97.39 | 97.29 |
| Viscosity, Sec/20 G | 31.6 | 20 | 7 | 9.7 | 12.00 |
| Gravity, #/Gallon | 8.87 | 9.11 | 9.4 | 9.89 | 10.33 |
| Channel Sag, inch | 0 | 0 | 0.175 | 0 | 0 |
| Shore A, Condition | 33 | 23.25 | 19 | 23 | 25 |
| Shore A, QUV | 32.3 | 23.75 | 19 | 22 | 25 |
| Tensile, psi | 190.7 | 166.4 | 135.4 | 145.2 | 185.1 |
| Elongation, % | 336.5 | 368.8 | 424.1 | 489 | 498.1 |
| 100% Modulus, psi | 101.6 | 81.1 | 42.7 | 47.6 | 74.2 |
| 50% Modulus, psi | 64.5 | 45.4 | 23.3 | 17.2 | 40.9 |
| 25% Modulus, psi | 37.9 | 26.6 | 11.8 | 7.8 | 23.2 |
| Peel-Glass, pli | 10.7 CF | 13.2 CF | 12 CF | 16.8 CF | 16.5 CF |
| Peel-Aluminum, pli | 10.2 CF | 12.5 CF | 12 CF | 17.3 CF | 16.6 CF |
| Peel-Concrete, pli | 8.8 CF/AF40/60 | 7.5 AF | 12 CF/AF90/10 | 16.8 CF/AF80/20 | 7.0 AF |

What is claimed is:

1. A curable composition with reduced density comprising:
a curable material; and
a density reducing material that decreases the density of the adhesive compound without substantially affecting the adhesive and sealant properties of the curable compound based on industry standards.

2. The composition of claim 1, wherein the curable material further comprises a modified silicone polymer.

3. The composition of claim 1, wherein the curable materials further comprises at least two different modified silicone polymers.

4. The composition of claim 1, wherein the density has been reduced by at least about 30 weight percent.

5. The composition of claim 1, wherein the density has been reduced between about 1 weight percent and about 30 weight percent.

6. The composition of claim 1, wherein the moisture content is reduced to less than about 500 parts per million without addition of a moisture scavenger

7. The composition of claim 1 wherein the density reducing material is a microspherical material.

8. The composition of claim 1 wherein the curable material comprises at least one polymer, at least one filler, at least one ultraviolet absorber, at least one solvent, and at least one hardening catalyst.

9. A method for preparing a curable composition with reduced density comprising the steps of:
obtaining a curable material; and
adding a density reducing material that decreases the density of the curable compound without substantially effecting the adhesive and sealant properties of the curable compound based on industry standards.

10. The method of claim 9, wherein the curable material further comprises a modified silicone polymer.

11. The method of claim 9, wherein the curable material further comprises at least two different modified silicone polymers.

12. The method of claim 9, wherein the density has been reduced by at least about 30 weight percent.

13. The method of claim 9, wherein the density has been reduced between about 1 weight percent and about 30 weight percent.

14. The method of claim 9, wherein the moisture content is reduced to less than about 500 ppm without the use of an addition of a moisture scavenger

15. The method of claim 9, wherein the density reducing material is a microspherical material.

16. The method of claim 9, wherein the curable material comprises at least one polymer, at least one filler, at least one ultraviolet absorber, at least one solvent, and at least one hardening catalyst.

17. A method for preparing a curable composition with reduced density comprising the steps of:
combining and grinding at least one polymer; at least one filler, at least on ultraviolet light absorber and at least one thixotropic agent;
adding a solvent and a placticizer and mixing to form a solution;
drying the solution by heating it under reduced pressure;
adding an adhesion promoter, a catalyst and a density reducing material; wherein the microspherical material reduces the overall density of the composition without substantially effecting the curable properties of the composition based on industry standards.

18. The method of claim 17, wherein at least on of the polymers is a modified silicone polymer.

19. The method of claim 17 wherein calcium carbonate is used as a filler.

20. The method of claim 17, wherein toluene is used as a solvent.

21. The method of claim 17, wherein the heating is to at least 240 degrees Fahrenheit.

22. The method of claim 17, wherein the density reducing material is a microspherical material
